(19) United States
(12) Patent Application Publication
(10) Pub. No.: US 2026/0326099 A1
(43) Pub. Date: Oct. 22, 2026

(54) MICRO-FLUIDIC CHIP AND OIL INJECTION METHOD

(71) Applicant: JIANGSU LOGILET BIOTECH CO., LTD., SUZHOU, JIANGSU (CN)

(72) Inventors: Pei DU, Suzhou (CN); Yang SU, Suzhou (CN)

(21) Appl. No.: 19/105,704

(22) PCT Filed: Oct. 8, 2023
(86) PCT No.: PCT/CN2023/123417

§ 371 Date: Feb. 21, 2025

(30) Foreign Application Priority Data
Oct. 8, 2022 (CN) 202211223452.7

(51) Int. Cl. B01L 3/00

(52) U.S. Cl. CPC B01L 3/502715; B01L 2200/027; B01L 2200/16; B01L 2300/044; B01L 2300/046; B01L 2300/0672; B01L 2300/0816; B01L 2300/0864; B01L 2300/0887

(57) ABSTRACT

The present application provides a microfluidic chip and an oil injection method. The microfluidic chip includes: a cover plate and a substrate arranged facing and spaced apart from each other, and a liquid injection shell, where a fluid chamber is formed between the cover plate and the substrate, and an oil inlet in communication with the fluid chamber is provided in the cover plate; a liquid injection shell has a first side and a second side opposite to each other, the second side being connected to the cover plate and/or the substrate.

### CROSS REFERENCE TO RELATED APPLICATIONS

The present application claims priority to Chinese Patent Application No. 2022112234527 filed on Oct. 8, 2022, the contents of which are incorporated herein by reference in their entirety.

### BACKGROUND

### Technical Field

The present application belongs to the technical field of microfluidic chips, and relates to a microfluidic chip and an oil injection method.

### Description of the Related Art

Test methods, such as qPCR, LAMP and immunoluminescence, are widely used in the fields of biology, medicine, etc. for determining whether a sample carries a gene associated with a genetic disease, diagnosing infectious diseases, detecting gene duplication, taking a paternity test, etc. In a traditional detection apparatus, it is usually necessary to use a pipette to draw up a certain amount of a liquid sample, align the pipette with an injection port, and inject the entire liquid into a reaction chamber. Using the pipette for sample injection results in increased use cost and high dependency on the pipette.

Digital microfluidic chips, based on the principle of electrowetting technology, regulate solid-liquid surface energy by electric potential and use unbalanced surface energy to drive liquid movement, so as to achieve precise micro-liquid control. A digital microfluidic chip mainly includes a transparent conductive cover (e.g., ITO glass), an electrode array that includes a hydrophobic layer and a dielectric layer on a surface thereof, etc., and a fluid chamber for droplet movement is provided between the transparent conductive cover and the electrode array. The digital microfluidic chips can integrate operation procedures, such as sampling, dilution, reagent addition, reaction, separation and testing, that are usually required in the fields of biology, chemistry, medicine, etc., can allow for less sample consumption than traditional means of manipulation while have the advantages of high sensitivity, high accuracy, high throughput and high integration, and can quickly realize automatic integration of an entire process of biochemical reaction at a low cost. Moreover, the entire process of reaction is fully closed without cross contamination, and can be operated with one button, which greatly frees an operator's hands.

During use of the microfluidic chips, in addition to reagent injection, it is also necessary to inject oil into the fluid chamber, and the oil functions to promote the flow of a liquid reagent in the fluid chamber. However, in the related art, oil is generally injected manually, which may be likely to introduce bubbles, thus affecting the use effect of digital microfluidic chips.

### BRIEF SUMMARY

Aiming at the disadvantages of the prior art, the present application provides a microfluidic chip and an oil injection method. An oil injection chamber in communication with a first exhaust channel is provided in a liquid injection shell, such that air in oil may be discharged through the first exhaust channel during oil injection, thereby reducing the bubble content of oil entering a fluid chamber.

According to an aspect of the present application, a microfluidic chip is provided. The microfluidic chip includes a cover plate and a substrate arranged facing and spaced apart from each other, a fluid chamber being formed between the cover plate and the substrate, and an oil inlet in communication with the fluid chamber being provided in the cover plate; and a liquid injection shell having a first side and a second side opposite to each other, the second side being connected to the cover plate and/or the substrate, wherein a first recess for holding an oil bubble cap that stores oil is formed in a first side surface of the liquid injection shell, a second side surface of the liquid injection shell and the cover plate jointly form at least an oil injection chamber, the first recess is in communication with the oil injection chamber via an oil injection channel formed in the liquid injection shell, the oil injection chamber is in communication with the oil inlet, and a first exhaust channel via which the oil injection chamber is in communication with the outside of the first side is further formed inside the liquid injection shell.

According to another aspect of the present application, an oil injection method for oil injection for a microfluidic chip is provided. The method includes: fitting an oil bubble cap into the first recess of the liquid injection shell, fitting a lyophilization bubble cap and a lyophilized bead into each of the first group of second recesses, and fitting a reagent bubble cap into each of the second group of second recesses; driving an oil injection head located above the first recess to move toward the first recess to a first height relative to the microfluidic chip to press the oil bubble cap to enable oil to flow into the fluid chamber and fill a first section that is a space in which the fluid chamber covers only the second group of liquid inlets; stopping the movement of the oil injection head for a preset period of time to enable injection of a reagent into the fluid chamber via the plurality of second recesses; and after liquid injection for all the second recesses, continuing to drive the oil injection head to move toward the first recess to a second height relative to the microfluidic chip to press the oil bubble cap to enable oil to fill the fluid chamber.

### BRIEF DESCRIPTION OF THE SEVERAL VIEWS OF THE DRAWINGS

FIG. 1 is a schematic exploded view of a microfluidic chip according to a specific embodiment of the present application;

FIG. 2 is a schematic structural diagram of a cover plate and a substrate of a microfluidic chip according to a specific embodiment of the present application;

FIG. 3 is a cross-sectional side view of a microfluidic chip according to a specific embodiment of the present application;

FIG. 4 is a schematic front view of a liquid injection shell of a microfluidic chip according to a specific embodiment of the present application;

FIG. 5 is a schematic rear view of the liquid injection shell of the microfluidic chip according to a specific embodiment of the present application;

FIG. 6 is a top view of a cover plate and a substrate according to a specific embodiment of the present application;

FIG. 7 is a flowchart of an oil injection method according to a specific embodiment of the present application; and

FIG. 8 is a schematic diagram of a first section filled up with oil.

### LIST OF REFERENCE SIGNS

cover plate 110, oil inlet 111, liquid inlet 112, first group 112a, second group 112b, sample injection port 113, exhaust hole 114;
substrate 120;
liquid injection shell 130, first recess 131, oil injection channel 132, spike 133, first exhaust channel 134a, second exhaust channel 134b, second recess 135, first group 135a, second group 135b, third recess 136, liquid injection tube 137a, sample tube 137b, oil injection chamber 138, first chamber 138a, second chamber 138b, third chamber 138c, exhaust chamber 139, partition wall 1391, flange 1392, outer flange 1392a, inner flange 1392b;
fluid chamber 140, first section 141; electrode 150; dielectric layer 160; hydrophobic layer 170; gap adhesive 180;
oil bubble cap 200; oil injection head 300.

### DETAILED DESCRIPTION

It should be understood that, in the description of the present application, the orientation or position relationships indicated by the terms such as “center”, “longitudinal”, “transverse”, “up”, “down”, “front”, “rear”, “left”, “right”, “vertical”, “horizontal”, “top”, “bottom”, “inside” and “outside” are based on the orientation or position relationships shown in the drawings and are merely for ease of description of the present application and for simplicity of the description, rather than indicating or implying that the device or element referred to must have a particular orientation or be constructed and operated in a particular orientation, and thus cannot be construed as a limitation on the present application.

It should be noted that in the description of the present application, unless otherwise explicitly specified and defined, the terms “arrangement”, “connecting” and “connection” should be understood in a broad sense, for example, they may be a fixed connection, a detachable connection, or an integrated connection; or may be a mechanical connection or an electrical connection; or may be a direct connection, an indirect connection by means of an intermediate medium, or internal communication between two elements. For those of ordinary skill in the art, the specific meaning of the terms mentioned above in the present application can be construed according to specific circumstances.

The technical solution of the present application will be further described below with reference to the specific embodiments.

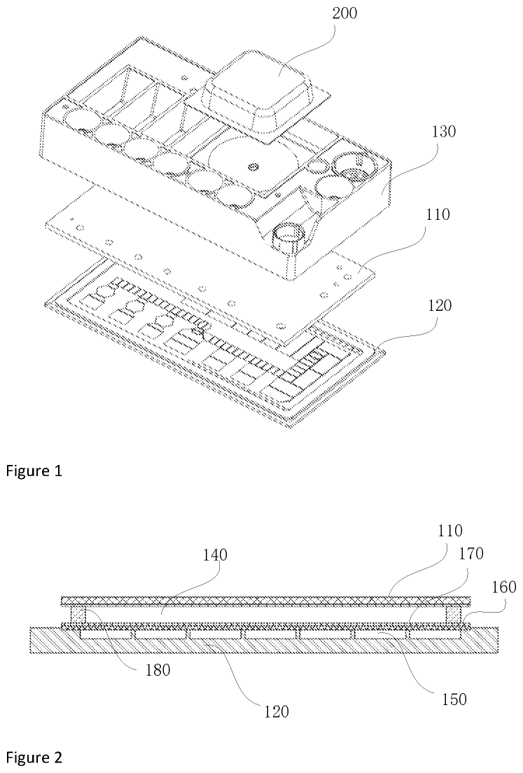

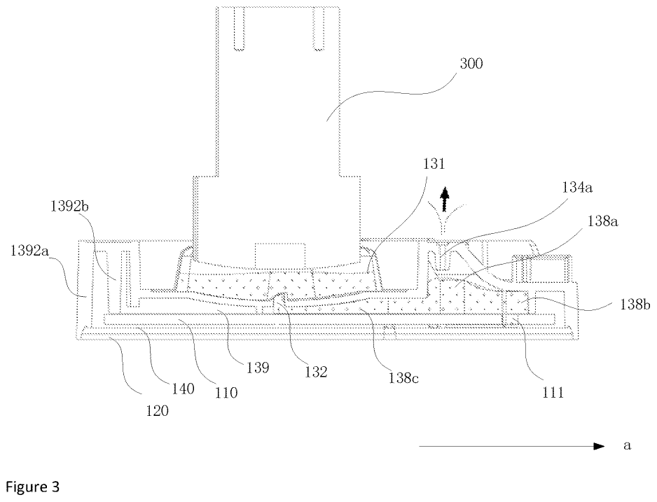

According to an aspect of the present application, an embodiment of the present application first provides a microfluidic chip. FIG. 1 is a schematic exploded view of a microfluidic chip according to a specific embodiment of the present application, FIG. 2 is a schematic structural diagram of a cover plate and a substrate of a microfluidic chip according to a specific embodiment of the present application, and FIG. 3 is a cross-sectional side view of a microfluidic chip according to a specific embodiment of the present application. As shown in the figures, the microfluidic chip includes: a cover plate 110 and a substrate 120 arranged facing and spaced apart from each other, and a liquid injection shell 130.

As shown in FIGS. 2 and 3, a fluid chamber 140 is formed between the cover plate 110 and the substrate 120, and an oil inlet 111 in communication with the fluid chamber 140 is provided in the cover plate 110. The cover plate 110 and the substrate 120 may be rectangular plates, and are similar in size and shape and spaced apart by a small distance, so that a thin rectangular space, i.e., the fluid chamber 140, may be formed between them, and a reagent, a sample, oil, etc. that will be subsequently injected into the microfluidic chip will flow within the fluid chamber 140. As an example, the cover plate 110 may be a glass plate, further preferably ITO glass, and the cover plate 110 is further provided with a hydrophobic layer over an ITO conductive layer. The cover plate 110 may be transparent such that an external optical module for test may collect a fluorescence signal generated by an amplification reaction to enable a user to observe the flow of an internal liquid. The substrate 120 is provided with an array of microelectrodes 150, and a dielectric layer 160 and a hydrophobic layer 170 are sequentially stacked on the array of microelectrodes 150. The microelectrodes 150 drive liquid to move, achieving precise control on micro-liquid.

In some embodiments, the cover plate 110 and the substrate 120 are bonded to each other by means of a gap adhesive 180 provided on a periphery. High-precision gap beads of a preset thickness are provided in the gap adhesive 180. The gap beads are spaced apart from each other by a certain distance and distributed circularly such that the cured gap adhesive 180 has a uniform and stable thickness. Since there is a safety distance between the inner side of the gap adhesive 180 and the microelectrodes 150, the gap adhesive 180 enables formation of the fluid chamber 140 as desired between the cover plate 110 and the substrate 120 and can ensure the airtightness of the fluid chamber 140. In some other embodiments, the cover plate 110 and the substrate 120 may also be bonded to each other in other feasible ways, as long as it is possible to ensure that a certain gap is maintained between the cover plate 110 and the substrate 120.

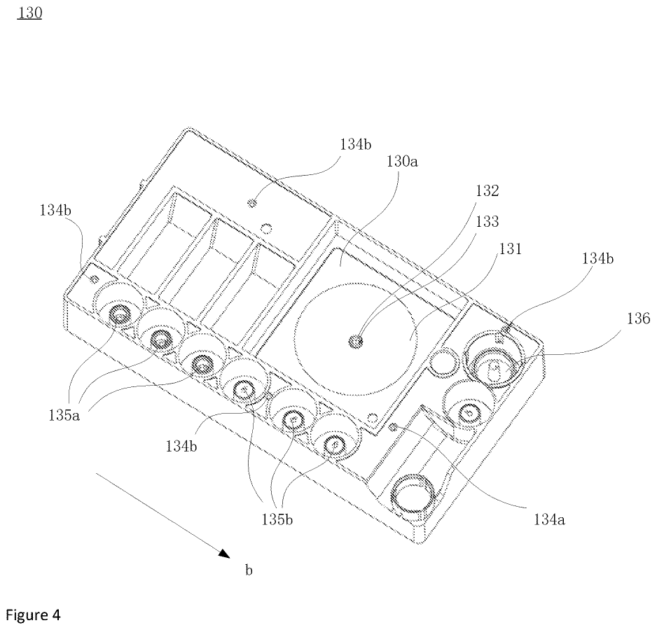

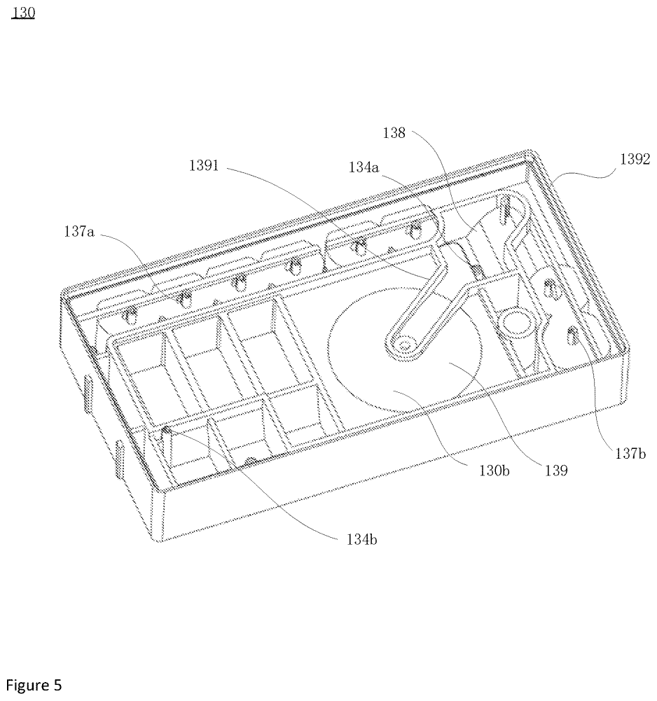

The liquid injection shell 130 is configured to assist in injection of various liquids (samples, reagents, oil, etc.) into the fluid chamber 140. FIG. 4 is a schematic front view of a liquid injection shell of a microfluidic chip according to a specific embodiment of the present application; and FIG. 5 is a schematic rear view of the liquid injection shell of the microfluidic chip according to a specific embodiment of the present application. As shown in FIGS. 4 and 5, the liquid injection shell 130 has a first side and a second side (i.e., a front side and a rear side) opposite to each other, the second side being connected to the cover plate 110 and/or the substrate 120, and the first side facing away from the cover plate 110 and the substrate 120. A first recess 131 for holding an oil bubble cap 200 that stores oil is formed in a first side surface 130a of the liquid injection shell 130. The above first recess 131 may be arranged in the center of the first side surface 130a and is a circular recess. In some other embodiments, the first recess 131 may also be provided at other positions in the first side surface 130a, such as at an edge of the first side surface 130a, and may be shaped as a rectangle, a triangle, etc. During the fitting process for the oil bubble cap 200, the periphery of the oil bubble cap 200 may be bonded to the liquid injection shell 130 by an adhesive to ensure the periphery of the oil bubble cap 200 to be sealed with the liquid injection shell 130, such that oil can only flow to a second side surface 130b and will not overflow after the oil bubble cap 200 is punctured. The second side surface 130b of the liquid injection shell 130 and the cover plate 110 jointly form at least an oil injection chamber 138. Since an upper surface of the cover plate 110 is flat, the oil injection chamber 138 has a flat bottom surface, facilitating the unobstructed flow of oil. However, the second side surface 130b of the liquid injection shell 130 is not flat, meaning that the oil injection chamber 138 varies in height at different positions. As shown in FIG. 3, the first recess 131 is in communication with the oil injection chamber 138 via an oil injection channel 132 formed in the liquid injection shell 130, and an inlet of the oil injection channel 132 may be provided at the lowest position in the center of the first recess 131. The oil injection chamber 138 is also in communication with the oil inlet 111, that is, the portion of the cover plate that forms the oil injection chamber 138 covers the oil inlet 111. A first exhaust channel 134a via which the oil injection chamber 138 is in communication with the outside of the first side is further formed inside the liquid injection shell 130, and the first exhaust channel 134a is configured to discharge air from the oil injection chamber 138 to the outside of the first side. An outlet of the first exhaust channel 134a should be arranged outside the first recess 131 to prevent oil from entering the first exhaust channel 134a. The first exhaust channel 134a may extend in a direction perpendicular to the cover plate 110 to facilitate air exhausting.

The principle of operation of the microfluidic chip of this embodiment during an oil injection process is: when the oil bubble cap 200 arranged in the first recess 131 ruptures under a pressure, oil flows out of the oil bubble cap 200 into the oil injection chamber 138 through the oil injection channel 132. As the oil injection chamber 138 is gradually filled with oil, air in the oil injection chamber 138 is gradually discharged through the first exhaust channel 134a to the outside of the oil injection chamber 138 until the oil injection chamber 138 is filled up with the oil, and the oil in the oil injection chamber 138 flows into the fluid chamber 140 through the oil inlet 111. In the microfluidic chip of this embodiment, during the process of oil flowing into the oil injection chamber 138, bubbles inside the oil and inside the chamber are discharged by means of the first exhaust channel 134a, thereby reducing the bubble content of the oil entering the fluid chamber 140.

In some embodiments, a spike 133 is provided inside the first recess 131 for puncturing the oil bubble cap 200 when the oil bubble cap 200 disposed inside the first recess 131 is under a pressure, so as to enable the oil in the oil bubble cap 200 to flow out.

As shown in FIG. 3, in some embodiments, the oil injection chamber 138 includes at least a first chamber 138a and a second chamber 138b arranged in a first direction a, the first chamber 138a and the second chamber 138b being adjacent to and in communication with each other. The first direction a is a direction from the oil injection channel 132 toward the oil inlet 111, and as shown in FIG. 3, is indicated by arrow a in the figure. The portion of the second side surface 130b of the liquid injection shell 130 that forms the first chamber 138a is farther away from the cover plate 110 than the portion of the second side surface 130b of the liquid injection shell 130 that forms the second chamber 138b, that is, as shown in FIG. 3, the top of the first chamber 138a is higher than that of the second chamber 138b when the microfluidic chip is placed horizontally normally. The first exhaust channel 134a is in communication with the first chamber 138a, and the oil inlet 111 is in communication with the second chamber 138b.

The oil injection chamber 138 of the microfluidic chip in this embodiment includes the first chamber 138a and the second chamber 138b of different heights. After the oil enters the oil injection chamber 138, the second chamber 138b that is lower will be filled first, and accordingly, the remaining air in the oil injection chamber 138 will naturally be discharged through the first exhaust channel 134a in communication with the first chamber 138a. Thus, such a configuration is more conducive to the discharge of air in the oil to further reduce the amount of air that can enter the fluid chamber 140.

In addition, an inlet of the first exhaust channel 134a may be arranged at the portion, farthest from the cover plate 110, of the second side surface 130b of the liquid injection shell 130 that forms the first chamber 138a, that is, at the highest position of the top of the first chamber 138a, which can ensure that air in the oil injection chamber 138 can be completely discharged when the oil injection chamber 138 is filled up with oil, thus preventing the oil in the oil injection chamber 138 from being mixed with bubbles.

It should be added that, in another embodiment, the oil injection chamber 138 may include three or even more chambers which may be arranged in the first direction a mentioned above and have their heights decreasing gradually in the first direction a, the first exhaust channel 134a may be in communication with the highest chamber, and the oil inlet 111 may be in communication with the lowest chamber. The plurality of chambers arranged in this way can also achieve the effect of naturally discharging air from the oil injection chamber 138 through the first exhaust channel 134a.

In some embodiments, the oil injection chamber 138 further includes a third chamber 138c extending in the first direction, one end of the third chamber 138c being in communication with the oil injection channel 132, and the other end of the third chamber 138c being in communication with the first chamber 138a. As shown in FIGS. 3 and 5, the third chamber 138c is approximately an elongated channel for unobstructed delivery of oil from the outlet of the oil injection channel 132 to the first chamber 138a.

In some embodiments, at least a section of the second side surface 130b of the liquid injection shell 130 that forms the first chamber 138a obliquely extends toward the cover plate 110 in the first direction. As shown in FIG. 3, a top wall of the first chamber 138a is sloped downward in the first direction, and the closer the second chamber 138b is, the lower the top of the first chamber 138a is. Because of the low density of air, bubbles in the oil tend to be present on the surface of oil, and the section that is sloped of the second side surface 130b serves to block bubbles during the oil flowing from the first chamber 138a to the second chamber 138b, thereby preventing bubbles from entering the fluid chamber 140.

In order to provide proper arrangement of the space on the two sides of the liquid injection shell 130, the third chamber 138c may be arranged below the first recess 131, and the first chamber 138a is arranged in a side surface of the recess 131 and near the recess 131. Preferably, the first chamber 138a and the recess 131 may also share an inner wall of the liquid injection shell 130, as shown in FIG. 3.

In some embodiments, as shown in FIG. 5, the second side surface 130b of the liquid injection shell 130 and the cover plate 110 jointly form an exhaust chamber 139, and the exhaust chamber 139 and the oil injection chamber 138 may be isolated from each other by a partition wall 1391 arranged on the second side of the liquid injection shell. The exhaust chamber 139 may be configured to surround the oil injection chamber 138, and they are separated by the partition wall 1391 formed on the second side and protruding toward the cover plate 110. Therefore, the partition wall 1391 is configured to define the range of area of the oil injection chamber 138 and the exhaust chamber 139 in a horizontal plane. As shown in FIG. 5, the oil injection chamber 138 is defined by the second side surface 130b of the liquid injection shell, an upper surface of the cover plate 110 and the partition wall 1391, and the exhaust chamber 139 is defined by the second side surface 130b of the liquid injection shell, the upper surface of the cover plate 110, the partition wall 1391, and a flange 1392 at the edge of the liquid injection shell.

At least one second exhaust channel 134b via which the exhaust chamber 139 is in communication with the outside of the first side is further formed inside the liquid injection shell 130. A plurality of second exhaust channels 134b may be provided, and may be discretely distributed on the liquid injection shell 130 and be in communication with the exhaust chamber 139 at different positions.

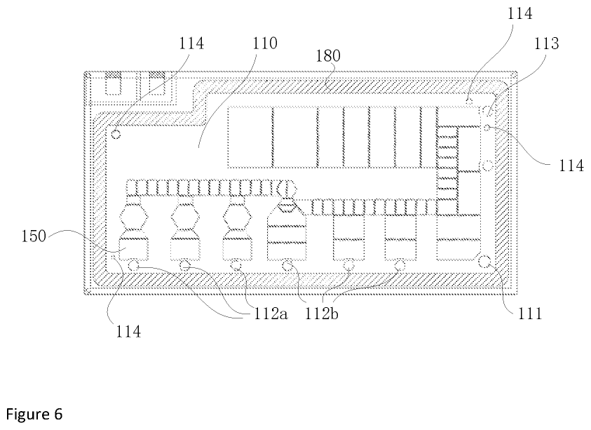

FIG. 6 is a top view of the cover plate 110 and the substrate 120 according to a specific embodiment of the present application. As shown in FIG. 6, at least one exhaust hole 114 in communication with the exhaust chamber 139 is provided in the cover plate 110. As shown in FIG. 6, a plurality of exhaust holes 114 may be provided, and the exhaust holes 114 may also be discretely arranged in the cover plate and be in communication with the fluid chamber 140 at different positions. For example, the exhaust holes 114 may be distributed at positions near the edge of the cover plate 110, that is, the exhaust holes 114 are in communication with the edge space of the fluid chamber 140. Such arrangement of the exhaust holes 114 is conducive to the discharge of air in the fluid chamber 140, because during oil injection, a middle section of the fluid chamber 140 will be filled up with oil first, and air will be expelled into the edge space of the fluid chamber 140, and thus, the exhaust holes 114 being arranged near the edge of the cover plate facilitate the discharge of air in the final stage of oil injection.

In this embodiment, the principle of discharging air from the fluid chamber 140 during oil injection is as follows. As oil is slowly injected into the fluid chamber 140, the middle section of the fluid chamber 140 is first filled up with oil, and air is expelled to the edge space of the fluid chamber 140 and is then discharged into the exhaust chamber 139 through the exhaust holes 114 in the cover plate. Finally, air in the exhaust chamber 139 is eventually discharged out of the microfluidic chip through the second exhaust channel 134b arranged in the liquid injection shell 130.

As shown in FIG. 3, in some embodiments, a flange 1392 protruding toward the cover plate 110 is provided on the periphery of the second side of the liquid injection shell 130, and a protruding end of the flange 1392 is configured to be connected to the cover plate 110 or the substrate 120. Inner and outer flanges 1392 may be provided on the periphery of the second side of the liquid injection shell 130, the inner flange 1392b being configured to be connected to the cover plate 110 and form an outer wall that defines the exhaust chamber 139, and the outer flange 1392a being configured to be connected to the substrate 120. Providing the inner and outer flanges 1392 can further increase the overall strength of connecting the liquid injection shell 130 to the cover plate 110 and the substrate 120. The inner and outer flanges 1392 are connected to the cover plate 110 and the substrate 120 by the ways including, but not limited to, gluing, snap-fitting, or screw connection.

In addition to the configuration related to oil injection, the microfluidic chip further includes the configuration related to sample injection and reagent injection, which will be described in detail below with reference to the figures.

As shown in FIG. 6, at least one liquid inlet 112 in communication with the fluid chamber is provided in the cover plate 110, and the liquid inlet 112 is configured to inject a reagent into the fluid chamber 140. A plurality of liquid inlets 112 may be provided, that is, different types of reagents may be injected into the fluid chamber 140 through the plurality of liquid inlets 112, respectively.

As shown in FIG. 4, at least one second recess 135 is further formed in the first side surface 130a of the liquid injection shell 130. Each second recess 135 corresponds to one liquid inlet 112 and is configured to hold a reagent bubble cap or a lyophilized bead that stores a reagent. The second recess 135 may be a circular recess like the first recess 131. However, since the amount of injected reagent is less than the amount of injected oil, the second recess 135 may be sized smaller than the first recess 131, and the plurality of second recesses 135 may be of the same size. The plurality of second recesses 135 may be arranged in a second direction b in a straight line. As shown in FIG. 4, six second recesses 135 are shown in the figure, and the six second recesses 135 extend along a straight line parallel to the edge of the liquid injection shell 130.

As shown in FIG. 5, at least one liquid injection tube 137a is provided on the second side of the liquid injection shell 130, one end of each liquid injection tube 137a being in communication with one second recess 135, and the other end thereof being in communication with a corresponding liquid inlet 112. The liquid injection tube 137a preferably extends vertically, that is, each liquid inlet 112 is arranged directly below a corresponding second recess 135, thus facilitating the flow of the reagent. The principle of reagent injection of the microfluidic chip of this embodiment is that after a reagent flows into one of the second recesses 135, the reagent flows through a corresponding liquid injection tube 137a to a corresponding liquid inlet 112 arranged in the cover plate 110. Then, the reagent flows to a corresponding position in the fluid chamber 140 through the liquid inlet 112. An electrode 150 is arranged below this position. The electrode 150 at the corresponding position needs to be turned on before the liquid flows to the corresponding position in the fluid chamber 140, and subsequently, the electrode 150 may control the flow of the reagent above it.

The sample injection is also based on the same principle. As shown in FIG. 4, a sample injection port 113 in communication with the exhaust chamber 139 is provided in the cover plate 110, and a third recess 136 is also formed in the first side surface 130a of the liquid injection shell 130. The third recess 136 is configured to hold a sample, and a sample tube 137b is arranged on the second side of the liquid injection shell 130, one end of the sample tube 137b being in communication with the third recess 136, and the other end of the sample tube being in communication with the sample injection port 113. The sample injection principle of the microfluidic chip of this embodiment is that after flowing into the third recess 136, the sample flows to a corresponding sample injection port provided in the cover plate along a corresponding sample tube 137b. Then, the sample flows to the corresponding position in the fluid chamber 140 through the sample injection port 113. An electrode 150 is provided below this position, and subsequently, the electrode 150 may control the flow of the sample above it.

In some embodiments, the plurality of second recesses 135 are of different types, some of the plurality of second recesses 135 being configured to hold reagent bubble caps, and the other being configured to hold lyophilized beads. Both the reagent bubble caps and the lyophilized beads may produce reagents. Specifically, the reagent bubble cap and the oil bubble cap 200 are based on similar principles, in which the reagent in the reagent bubble cap is enclosed by an outer bubble cap, and when the reagent bubble cap ruptures by an external force, the reagent liquid inside the reagent bubble cap will flow out and further flow into the second recess 135. The lyophilized bead stores a reagent that is lyophilized. During use, the lyophilized bead is used with the lyophilization bubble cap. A diluent for washing and diluting the lyophilized bead is stored in the lyophilization bubble cap. The lyophilization bubble cap ruptures by an external force during use, the diluent inside the lyophilization bubble cap will flow out, the lyophilized bead is exposed to the diluent, and the reagent of the lyophilized bead melts and is diluted and then enters the corresponding liquid injection tube 137a.

The plurality of second recesses 135 are divided into two groups according to the type of consumables that store reagents and are placed in the second recesses. The plurality of second recesses 135 include a first group 135a of second recesses 135 and a second group 135b of second recesses 135, each second recess 135 of the first group 135a of second recesses 135 is configured to hold the lyophilization bubble cap and the lyophilized bead, and each second recess 135 of the second group 135b of second recesses 135 is configured to hold the reagent bubble cap. Correspondingly, a plurality of liquid inlets 112 is provided in the cover plate 110. The plurality of liquid inlets 112 include a first group of liquid inlets 112 and a second group of liquid inlets 112, in which each liquid inlet 112 of the first group 112a of liquid inlets 112 is in communication with a corresponding second recess 135 of the first group of second recesses 135, each liquid inlet 112 of the second group 112b of liquid inlets 112 is in communication with a corresponding second recess 135 of the second group of second recesses 135, and the second group of liquid inlets 112 is closer to the oil inlet 111 than the first group of liquid inlets 112.

As shown in FIG. 4, the six second recesses 135 shown in the figure are divided into two groups, i.e., the first group 135a of second recesses 135 and the second group 135b of second recesses 135, each group including three second recesses 135. Correspondingly, the sixth liquid inlets 112 shown in FIG. 6 are also divided into two groups, i.e., the first group 112a of liquid inlets 112 and the second group 112b of liquid inlets 112, each group including three liquid inlets 112. The plurality of second recesses 135 and the plurality of liquid inlets 112 shown in the figures are arranged in the second direction b, and each group of second recesses 135 or each group of liquid inlets 112 includes three adjacent second recesses 135 or liquid inlets 112. In some other embodiments, the plurality of second recesses 135 may not necessarily be arranged in a straight line, and the plurality of second recesses 135 may also be arranged in a circular shape or distributed in clusters, for example. However, regardless of the arrangement, the plurality of recesses are divided into two groups, including the first group 135a of second recesses 135 and the second group 135b of second recesses 135.

The second group 112b of liquid inlets 112 is closer to the oil inlet 111 than the first group 112a of liquid inlets 112. As shown in FIG. 6, in the case where the oil inlet 111 is arranged at one corner of the cover plate, the second group 112b of liquid inlets 112 is closer to the corner and the first group 112a of liquid inlets 112 are farther away from the corner. Thus, during oil injection, oil will first fill the space where the second group 112b of liquid inlets 112 of the fluid chamber 140 is located and then fill the space where the first group 112a of liquid inlets 112 of the fluid chamber 140 is located.

In the case where the consumable for storing the reagent is the lyophilized bead, the lyophilized bead is disposed at an opening of a corresponding second recess 135 that is in communication with the liquid injection tube 137a. It can be understood that since the lyophilized bead is a solid and fits with the opening of the liquid injection tube 137a in a non-tight manner, it is likely to generate more bubbles during liquid injection, and the bubbles injected here will affect the subsequent amplification reaction. The reagent bubble cap that stores the reagent may directly provide a liquid reagent to the liquid injection tube 137a. In this case, it is not likely to generate bubbles, or only acceptable tiny bubbles will be generated. Therefore, during oil injection, when the space where the second group 112b of the liquid inlets 112 of the fluid chamber 140 is located is filled up with oil, the oil injection may stop, and then a liquid injection operation may be performed. For the second group 135b of second recesses 135 where the reagent bubble caps are located, the space where the corresponding liquid inlets 112 are located has been filled with oil. Since the reagent bubble caps are not likely to generate bubbles, the reagent can be injected in the presence of the oil without introducing bubbles or only injecting acceptable tiny bubbles. For the first group 135a of second recesses 135 where the lyophilized beads are located, the space where the corresponding liquid inlets are located has not yet been filled with oil, so that even if bubbles are introduced during liquid injection, these bubbles can be discharged from the exhaust hole 114 during the subsequent oil injection process. Therefore, the arrangement and distribution of the second recesses 135 and the corresponding liquid inlets 112 in this embodiment are conducive to avoiding the generation of bubbles in the fluid chamber 140.

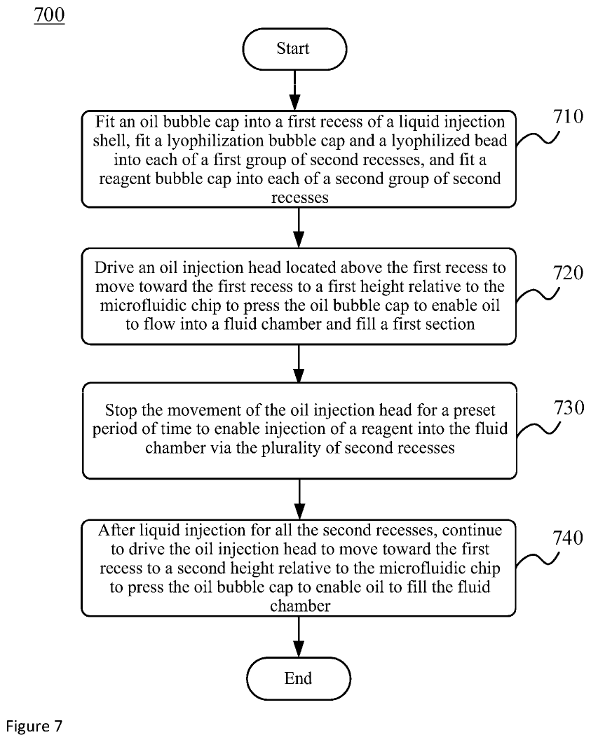

According to another aspect of the present application, further provided is an oil injection method for oil injection for a microfluidic chip. The oil injection method is applicable to the microfluidic chip having two groups of second recesses 135 and two groups of liquid inlets 112 as described above. As shown in FIG. 7, the oil injection method 700 includes:
step 710: fitting an oil bubble cap 200 into a first recess 131 of a liquid injection shell 130, fitting a lyophilization bubble cap and a lyophilized bead into each second recess 135 of a first group of second recesses 135, and fitting a reagent bubble cap into each second recess 135 of a second group of second recesses 135;
step 720: driving an oil injection head 300 located above the first recess 131 to move toward the first recess 131 to a first height relative to the microfluidic chip, so as to press the oil bubble cap 200 to drive oil to flow into a fluid chamber 140 and fill a first section 141, where the first section 141 is a space in which the fluid chamber 140 covers only a second group of liquid inlets 112;
step 730: stopping the movement of the oil injection head 300 for a preset period of time to enable the injection of a reagent into the fluid chamber 140 via the plurality of second recesses 135; and
step 740: and after all the second recesses 135 are filled with liquid, continuing to drive the oil injection head 300 to move toward the first recess 131 to a second height relative to the microfluidic chip, so as to press the oil bubble cap 200 to allow oil to fill the fluid chamber 140

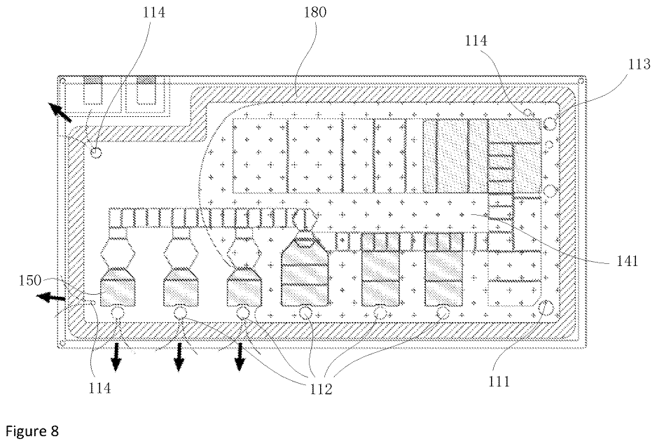

In the method of this embodiment, the oil injection head 300 may press the oil bubble cap 200 downward such that oil flows out of the oil bubble cap 200. The oil injection head 300 may be driven by a motor to move in a vertical direction. In the step 720, the oil injection head 300 moves downward from an initial position above the first recess 131, and then presses the oil bubble cap 200 to drive oil to flow into and gradually fill the fluid chamber 140. When the oil injection head 300 is pressed downward to the first height, the first section 141 is filled with the oil, the first section 141 being a space of the fluid chamber 140 that covers the second group of liquid inlets 112. As shown in FIG. 8, FIG. 8 shows a schematic diagram of the first section 141 being filled up with oil.

In the step 730, since the oil injection head 300 stops pressing downward, the oil filling state will remain in the state shown in FIG. 8. At this point, reagents are injected into the fluid chamber 140 by means of the reagent bubble caps or lyophilized beads in the plurality of second recesses 135. Similar to the oil injection process, for each second recess 135, a liquid injection head may also be used to press the reagent bubble cap or the lyophilization bubble cap for diluting the lyophilized bead to release the reagent.

In the step 740, after the liquid injection is completed, the oil injection head 300 is driven to move downward to the second height relative to the microfluidic chip so as to fill up the fluid chamber 140 with oil. As described above, such an oil injection sequence is conducive to avoiding the generation of bubbles in the fluid chamber 140.

In some embodiments, prior to stopping the movement of the oil injection head 300 for a preset period of time, the oil injection head 300 is moved away from the first recess 131 by a preset distance. During liquid injection, the fluid chamber 140 is further filled up with liquid and oil, which may result in the first group of liquid inlets 112 being covered with oil. Therefore, the oil injection head 300 may be retracted upward by a short distance prior to the liquid injection, which may provide a margin for the reagent injected into the fluid chamber 140, avoiding the first group 112a of liquid inlets 112 being covered with oil.

In some embodiments, the speed at which the oil injection head 300 moves from the first height to the second height is less than the speed at which the oil injection head 300 moves from an initial height to the first height. It is necessary to fill the entire fluid chamber 140 and discharge all air in the second stage of the oil injection operation (the step 740 in the method 700), the movement speed of the oil injection head 300 in this stage may thus be slightly less than the movement speed of that in the first stage of the oil injection operation (the step 720 in the method 700) to prevent oil from overflowing from the microfluidic chip under an excessive pressure.

After the oil injection is completed and prior to the operation on the microfluidic chip, it is necessary to ensure that the oil injection head 300 is slowly lifted off the surface of the oil bubble cap 200 to prevent the pressure applied to the microfluidic chip by the oil injection head 300 from affecting the movement of the liquid.

The applicant gives notice that the foregoing descriptions are only specific embodiments of the present application, but are not intended to limit the scope of protection of the present application. Those skilled in the art shall understand that any variation or replacement readily conceived by those skilled in the art within the technical scope disclosed in the present application shall fall within the scope of protection of the present application.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A microfluidic chip, comprising:
a cover plate and a substrate arranged facing and spaced apart from each other, a fluid chamber being formed between the cover plate and the substrate, and an oil inlet in communication with the fluid chamber being provided in the cover plate; and
a liquid injection shell having a first side and a second side opposite to each other, the second side being connected to the cover plate and/or the substrate, wherein a first recess for holding an oil bubble cap that stores oil is formed in a first side surface of the liquid injection shell, a second side surface of the liquid injection shell and the cover plate jointly form at least an oil injection chamber, the first recess is in communication with the oil injection chamber via an oil injection channel formed in the liquid injection shell, the oil injection chamber is in communication with the oil inlet, and a first exhaust channel via which the oil injection chamber is in communication with the outside of the first side is further formed inside the liquid injection shell.

2. The microfluidic chip according to claim 1, wherein
the oil injection chamber comprises at least a first chamber and a second chamber arranged in a first direction that is a direction from the oil injection channel toward the oil inlet, wherein the portion of the second side surface of the liquid injection shell that forms the first chamber is farther away from the cover plate than the portion of the second side surface of the liquid injection shell that forms the second chamber, the first exhaust channel is in communication with the first chamber, and the oil inlet is in communication with the second chamber.

3. The microfluidic chip according to claim 2, wherein
the oil injection chamber further comprises a third chamber extending in the first direction, one end of the third chamber being in communication with the oil injection channel, and the other end of the third chamber being in communication with the first chamber.

4. The microfluidic chip according to claim 2, wherein
an inlet of the exhaust channel is arranged at the portion, farthest away from the cover plate, of the second side surface of the liquid injection shell that forms the first chamber.

5. The microfluidic chip according to claim 2, wherein
at least a section of the second side surface of the liquid injection shell that forms the first chamber obliquely extends toward the cover plate in the first direction.

6. The microfluidic chip according to claim 1, wherein
the second side surface of the liquid injection shell and the cover plate further jointly form an exhaust chamber that is isolated from the oil injection chamber, and at least one second exhaust channel via which the exhaust chamber is in communication with the outside of the first side is further formed inside the liquid injection shell, wherein
at least one exhaust hole in communication with the exhaust chamber is provided in the cover plate.

7. The microfluidic chip according to claim 6, wherein
a partition wall protruding toward the cover plate is further formed on the second side of the liquid injection shell for isolating the exhaust chamber from the oil injection chamber.

8. The microfluidic chip according to claim 6, wherein
the cover plate is rectangular, and the oil inlet is arranged near a first corner of the cover plate.

9. The microfluidic chip according to claim 8, wherein
one of the at least one exhaust hole is arranged near a second corner of the cover plate, and wherein the second corner and the first corner are two corners in a diagonal of the cover plate.

10. The microfluidic chip according to claim 1, wherein
a spike is provided inside the first recess for puncturing the oil bubble cap when the oil bubble cap held inside the first recess is under a pressure to enable the oil in the oil bubble cap to flow out.

11. The microfluidic chip according to claim 1, wherein
at least one liquid inlet in communication with the fluid chamber is provided in the cover plate; and
at least one second recess is further formed in the first side surface of the liquid injection shell, wherein each second recess corresponds to one liquid inlet and is configured to hold a reagent bubble cap or a lyophilized bead that stores a reagent, at least one liquid injection tube is provided on the second side of the liquid injection shell, and each liquid injection tube has one end in communication with one second recess and the other end in communication with a corresponding liquid inlet.

12. The microfluidic chip according to claim 11,
wherein the at least one second recess is provided as a plurality of second recesses arranged in a second direction.

13. The microfluidic chip according to claim 1, wherein
a sample injection port in communication with the exhaust chamber is provided in the cover plate; and
a third recess is further formed in the first side surface of the liquid injection shell, wherein the third recess is configured to hold a sample, a sample tube is provided on the second side of the liquid injection shell, and the sample tube has one end in communication with the third recess and the other end in communication with the sample injection port.

14. The microfluidic chip according to claim 1, wherein
the cover plate and the substrate are bonded to each other by means of a gap adhesive provided on a periphery.

15. The microfluidic chip according to claim 1, wherein
a flange protruding toward the cover plate is provided on the periphery of the second side of the liquid injection shell, and a protruding end of the flange is configured to be connected to the cover plate or the substrate.

16. The microfluidic chip according to claim 11, wherein the at least one second recess is provided as a plurality of second recesses including a first group of second recesses and a second group of second recesses, each of the first group of second recesses being configured to hold a lyophilization bubble cap and a lyophilized bead, and each of the second group of second recesses being configured to hold a reagent bubble cap, and
a plurality of liquid inlets is provided in the cover plate and include a first group of liquid inlets and a second group of liquid inlets, wherein each of the first group of liquid inlets is in communication with a corresponding second recess of the first group of second recesses, each of the second group of liquid inlets is in communication with a corresponding second recess of the second group of second recesses, and the second group of liquid inlets is closer to the oil inlet than the first group of liquid inlets.

17. An oil injection method for oil injection for a microfluidic chip according to claim 16, the oil injection method comprising:
fitting an oil bubble cap into the first recess of the liquid injection shell, fitting a lyophilization bubble cap and a lyophilized bead into each of the first group of second recesses, and fitting a reagent bubble cap into each of the second group of second recesses;
driving an oil injection head located above the first recess to move toward the first recess to a first height relative to the microfluidic chip to press the oil bubble cap to enable oil to flow into the fluid chamber and fill a first section that is a space in which the fluid chamber covers only the second group of liquid inlets;
stopping the movement of the oil injection head for a preset period of time to enable injection of a reagent into the fluid chamber via the plurality of second recesses; and
after liquid injection for all the second recesses, continuing to drive the oil injection head to move toward the first recess to a second height relative to the microfluidic chip to press the oil bubble cap to enable oil to fill the fluid chamber.

18. The oil injection method according to claim 17, further comprising:
prior to stopping the movement of the oil injection head for a preset period of time,
moving the oil injection head away from the first recess by a preset distance.

19. The oil injection method according to claim 17, wherein
the speed at which the oil injection head moves from the first height to the second height is less than the speed at which the oil injection head moves from an initial height to the first height.
